(19) United States
(12) Patent Application Publication
(10) Pub. No.: US 2008/0098213 A1
(43) Pub. Date: Apr. 24, 2008

(54) Method of Providing Digital Certificate Functionality

(75) Inventors: Thomas Andreas Maria Kevenaar, Eindhoven (NL); Geert Jan Schrijen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,571

(22) PCT Filed: Jul. 4, 2005
(86) PCT No.: PCT/IB05/52224

§ 371 Date: Jan. 3, 2007

(30) Foreign Application Priority Data
Jul. 8, 2004 (EP) 04103254.1

(51) Int. Cl. H04L 9/30; H04L 9/08

(52) U.S. Cl. 713/156

(57) ABSTRACT

There is described a method of providing certification functionality. The method involves: (a) at a certification authority (20), generating a secret P, applying the secret P to sign a data string (m_{A}) on behalf of a first device (30, A), and communicating (50) the signed string to the first device (30, A); (b) communicating (60) secret information from the authority (20) to a second device (B, 40), the secret information for verifying authenticity of the string (m_{A}), the second device (40, B) being operable to use the secret information to generate a second key (k_{AB2}); (c) generating a first key (k_{AB1}) at the first device (30, A) using public information pertaining to the second device (40, B), said first key (k_{AB}I) being susceptible to generation provided that the string is authentic; (d) applying the second key (k_{AB2})to protect data for communication from the second device (40, B) to the first device (30, A); and (e) at the first device (30, A), applying the first key (k_{AB1})to access the protected data communicated from the second device (40, B) to the first device (30, A).

### FIELD OF THE INVENTION

The present invention relates to methods of providing digital certificate functionality, for example to a method of providing digital certificate functionality with implicit verification. Moreover, the invention also relates to apparatus and systems arranged to implement the methods. Furthermore, the invention concerns digital certificates and associated data generated when implementing the methods.

### BACKGROUND TO THE INVENTION

Digital certificates are cryptographic entities which are useful when implementing cryptographic systems. A digital certificate is defined as being a digital signature issued by a certification authority (CA) on a corresponding string or message m. By issuing such a certificate, the CA thereby vouches for the authenticity of the string m. Other devices are able to verify authenticity of the string m by checking the signature.

Conventionally, digital certificates are frequently implemented using public key techniques. In such techniques, the certification authority (CA) owns a public-private key pair, wherein PCA, SCA denote public and private keys respectively. Moreover, the CA is operable to issue a certificate denoted by Cert_{CA}(m) pertaining to a string m using its private key SCA. Conveniently, if E(y, x) denotes encryption of an item x using a key y, the certificate Cert_{CA}(m) can take a form as described in Equation 1 (Eq. 1):

Cert_{CA}(m)=E(SCA,m) Eq. 1

although alternative forms for the certificate Cert_{CA}(m) are potentially possible. In order to reduce data size of the certificate Cert_{CA}(m), the certificate more beneficially takes a form as described in Equation 2 (Eq. 2):

Cert_{CA}(m)=E(SCA,h(m)) Eq. 2

wherein h denotes a one-way hash function for mapping an input of arbitrary length onto an output of length n to provide data compression, namely such that h(.), {0,1}*→{0,1}″. Thus, any device is then capable of explicitly verifying authenticity of the known string m by checking a decryption of the certificate Cert_{CA}(m) using the CA's public key PCA against m, or h(m) as appropriate. In such a verification procedure, it is not required that the CA remains on-line during verification.

Conventionally, a common use for certificates is to bind a device's public key to its corresponding identity, for example the aforesaid certificate Cert_{CA}(m) is used to associate a device's public key Pdev to its identity. In this case, the string m preferably includes the device's public key Pdev as well as its identity and additional information to qualify the binding, for example an expiration temporal limit pertaining whilst the device received a private key Sdev over some secure authenticated channel.

Similar functionality allowing verification of the authenticity of a string m can be obtained using known symmetrical key techniques. For such symmetrical techniques, the CA has a secret key KCA which it uses to generate an associated certificate Cert_{CA}(m) according to Equation 3 or 4 (Eq. 3 or 4) as appropriate:

Cert_{CA}(m)=E(KCA,m) Eq. 3

or

Cert_{CA}(m)=E(KCA,h(m)) Eq. 4

which is published together with the string m. If a device possessing a copy of the string m and the certificate Cert_{CA}(m) desires to verify authenticity of the copy of the string m, the device must supply to the CA the certificate Cert_{CA}(m) and the string m. On receiving the certificate Cert_{CA}(m), the CA will decrypt the received certificate Cert_{CA}(m) using the CA's secret key KCA and then subsequently verify that the string m derived from the received certificate Cert_{CA}(m) is equal to the received string m. The string m in such a situation beneficially includes key material and other attributes as described in the foregoing. However, symmetrical key techniques have associated therewith a problem that the CA needs to remain on-line for authentication purposes and the device requires the provision of an authenticated channel from the device to the CA, for example an authenticated channel based on a shared secret.

Thus, certificates based on the aforementioned public key techniques allow for more flexible cryptographic systems to be implemented which do not required an on-line connection to be provided to the CA in contradistinction to symmetrical key techniques which do require an on-line CA. However, the public key techniques suffer a technical problem of being much more expensive in terms of hardware and power consumption of such hardware to implement the techniques.

Approaches to generating a common secret data item, for example for certification purposes, are known. For example, in a published international PCT patent application WO 2004/028075 there is described a method of generating a common secret data item between a first user facility and a second user facility. The method involves each user facility executing mutually symmetrical operations on respective complementary data items. These complementary data items are based on respectively unique quantities which are at least in part secret. An outcome of the symmetrical operations is used in user facilities as the aforesaid secret data item. In particular, the method is based on defining complementary data belonging to a GAP Diffie-Hellmann Problem that is defined in an Abelian Variety. More particularly, the Abelian Variety has unity dimension through being an elliptic curve.

The inventor has thus appreciated that known approaches to providing digital certification functionality suffer from various problems including one or more of hardware cost, hardware operating power consumption, a need for authenticated channels, and a requirement that the CA be available on-line. These problems have prompted the inventor to devise the present invention to try to at least partially address these problems.

### SUMMARY OF THE INVENTION

An object of the present invention is to provide an alternative method of providing digital certification functionality.

According to a first aspect of the present invention, there is provided a method of providing digital certification functionality in a network comprising a certification authority (CA) and at least first (A) and second (B) devices connectable in communication with the authority (CA), the method including steps of:

(a) at the authority (CA), generating a secret P, applying the secret P to sign a data string (m_{A}) on behalf of the first device (A), and then communicating the signed string to the first device (A);
(b) communicating secret information from the authority to the second device (B), said secret information for verifying authenticity of the string (m_{A}), the second device (B) being operable to use the secret information to generate a second key (k_{AB2}) for verifying authenticity of the string (m_{A});
(c) generating a first key (k_{AB1}) at the first device (A) using public information pertaining to the second device (B), said first key (k_{AB1}) being susceptible to generation provided that the string (m_{A}) is authentic;
(d) applying the second key (k_{AB2}) to protect data for communication from the second device (B) to the first device (A); and
(e) at the first device (A), applying the first key (k_{AB1}) to access the protected data communicated from the second device (B) to the first device (A).

The method is of advantage in that verification or authentication of the protected data does not require on-line availability of the certifying authority.

Preferably, in the method, accessing the protected data in step (e) is implemented without requiring on-line access to the authority during verification.

Preferably, in the method, the secret P is a bi-variate polynomial.

Preferably, in the method, the first key (k_{AB1}) is a polynomial evaluated using a public string relating to the second device.

Preferably, in step (a) of the method, the signed string is communicated secretly from the authority to the first device (A). More preferably, such secret communication is achieved by using encryption techniques.

Preferably, in the method, verification of the communicated protected data at the first device (A) is explicit. Alternatively, in the method, verification of the communicated protected data at the first device (A) is implicit.

Preferably, the method is based on at least one of: Blom's scheme, Identity Based Encryption (IBE).

According to a second aspect of the invention, there is provided a communication system including a certification authority (CA) and a plurality of devices arranged in mutual communication, the system being operable according to the method of the first aspect of the invention.

According to a third aspect of the invention, there is provided a digital certificate for data verification in a communication network operable according to a method of the first aspect of the invention.

According to a fourth aspect of the invention, there is provided encrypted data susceptible to verification by applying a method according to the first aspect of the invention. Preferably, the data includes audio and video program content.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

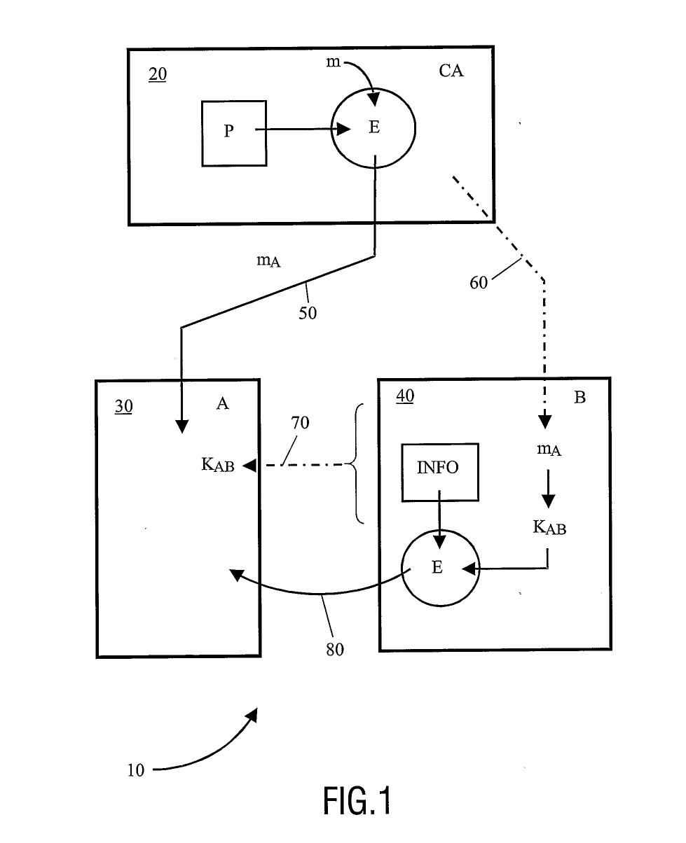

FIG. 1 is a schematic diagram of a communication network comprising a certifying authority in communication with two devices, the authority and the devices being operable to mutually communicate using digital certification according to the invention;

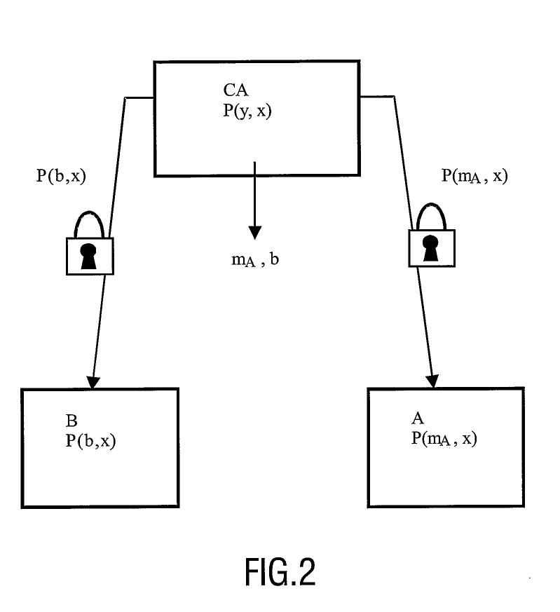

FIG. 2 is a schematic diagram of certificate distribution in the network depicted in FIG. 1;

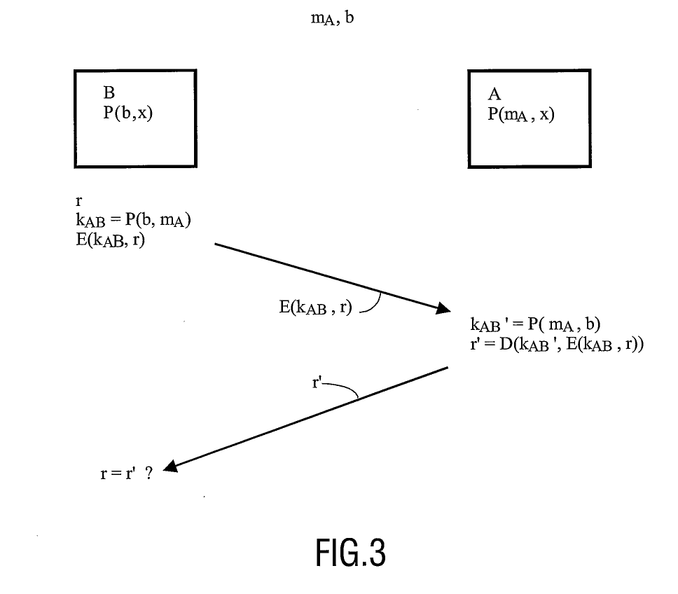

FIG. 3 is a schematic illustration of explicit string certification according to the invention;

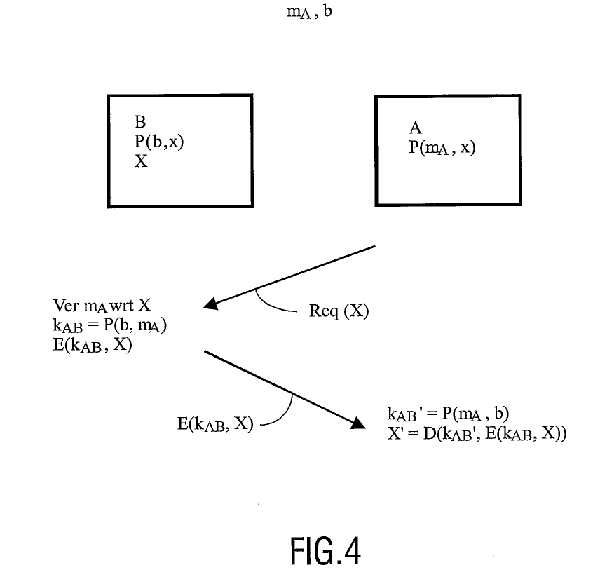

FIG. 4 is a schematic illustration of implicit string certification according to the invention; and

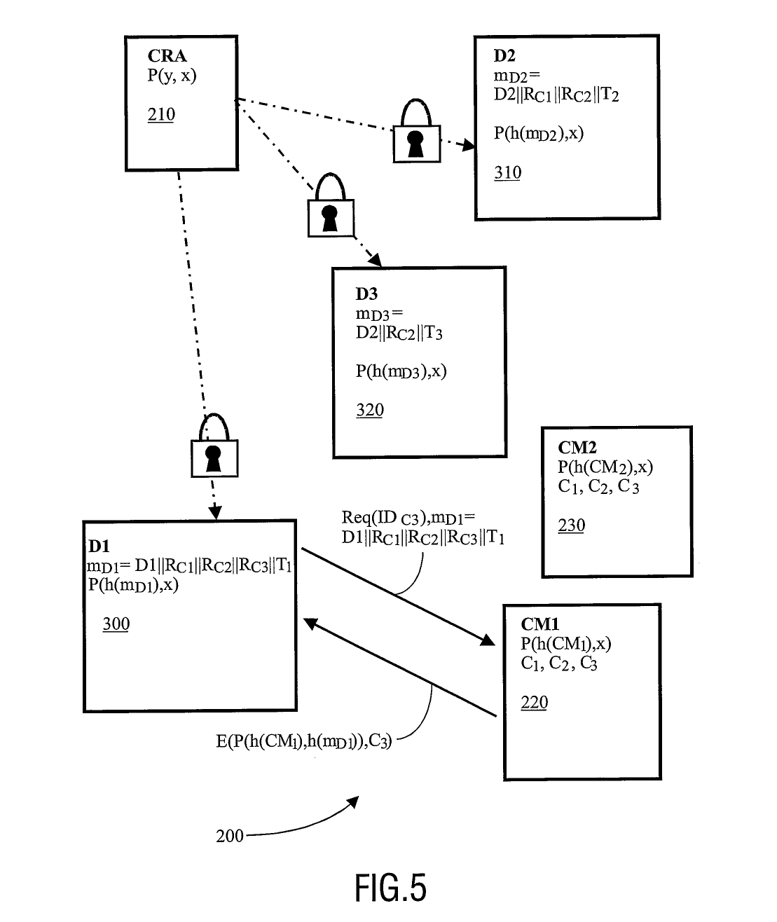

FIG. 5 is a schematic diagram of a system implementing digital certification functionality according to the invention.

### DESCRIPTION OF EMBODIMENTS OF THE INVENTION

The inventors have envisaged that it is feasible to provide digital certification functionality based on polynomials. Such an approach is potentially cheaper to implement than aforementioned public key techniques, and is capable of providing further benefits of more flexibility than aforementioned symmetrical key techniques which require an on-line server.

In overview, the invention concerns a method of providing digital certification functionality as depicted in FIG. 1. In FIG. 1, there is shown a communication network indicated generally by 10 including a certification authority (CA) 20, a first device (A) 30 and a second device (B) 40. The authority 20 and the devices 30, 40 are coupled so that they are capable of mutually communicating. The network 10 can be implemented as a communication system wherein the certification authority (CA) 20 is a server or database, and the devices are user apparatus coupled via the network 10 to the server or database.

In a first step of the method, the CA 20 chooses or generates a random secret P. The CA 20 then uses the secret P to sign a publicly disclosed string m_{A} on behalf of the first device A 30, whereafter the CA 20 secretly communicates the signed string m_{A} to the first device A 30 as depicted by an arrow 50 in FIG. 1.

In a second step of the method, the second device B 40 obtains some secret information denoted by an arrow 60 from the CA 20 and thereby enabling the second device B 40 to generate a key KAB to implicitly or explicitly verify the authenticity of the string m_{A}.

In a third step of the method, the first device A 30, by using some publicly available information 70 on the second device B 40, is operable to generate the key KAB provided that the string m_{A} used by the device B is authentic.

In a fourth step of the method, the second device B 40 uses its key KAB to protect data (INFO) communicated as denoted by an arrow 80 from the second device B 40 to the first device A 30. The first device A 30 is operable to employ its key KAB to access the data (INFO).

Although FIG. 1 depicts the method of the invention in overview, its steps will now be elucidated in more detail. The system 10 exploits polynomials in order to provide digital certificate functionality, more specifically a development based on Blom's key establishment scheme as described in a publication “Non-public key distribution”, Advances in Cryptology—Proceedings of Crypto 82 pp. 231-236, 1983 which is hereby incorporated by reference.

In Blom's scheme, a network has N users, and every message transmitted in the network is enciphered with a key of M bits, said key being unique for each pair of source-destination users involved. The scheme is operable to construct a key scheme that requires storage of a least possible number of bits at each user. In the scheme, the number of bits required is referred as the size of the user storage denoted by S. When there are N users in the network such that each user is defined by a unique user number i in a range of 0 to N−1, a user address aᵢ of user i is expressible as a vector as described in Equation 5 (Eq. 5):

aᵢ=(aᵢ₀,aᵢ₁, . . . ,aᵢ₍ₗ₋₁₎) Eq. 5

where 1=log_{b}(N) and wherein user numbers in a radix b are included as described by Equation 6 (Eq. 6):

$$i = {\sum }_{m = 0}^{l - 1} {a}_{im} {b}^{m} \qquad Eq . 6$$

There is also defined cumulative functions f according to Equations 7 to 9 (Eq. 7 to 9):

fₘ(x,y)−fₘ(y,x) Eq. 7

wherein

x,yε{0,1,2, . . . ,b−1} Eq. 8

mε{0, . . . ,l−1} Eq. 9

In Blom's scheme, a key kᵢⱼ for communication between users i and j is then described by Equation 10 (Eq. 10):

$${k}_{ij} = {\sum }_{m = 0}^{l - 1} {f}_{m} ( {a}_{im} , {a}_{jm} ) \qquad Eq . 10$$

wherein it is assumed that functions fₘ(.,.) have subsets of the Galois field GF(2^{M}) as their respective range of values and do not have any other property than commutativity. In calculating keys kᵢⱼ according to Blom's scheme, the user i always uses fₘ(aᵢₘ,.) and thus only has to store b values for each function.

The Blom's scheme uses a polynomial p(x,y) in the Galois field GF(q), the polynomial p(x, y) having a property that p(x,y)=p(y, x) and that each user is associated with an unique element i in the Galois field GF(q) where the element i is useable to identify the user. It is also assumed that q is in the order of 2^{M} for representing the elements of the Galois field GF(q) with M bits. To generate a key for users i and j, the polynomial p(i, j) is evaluated. Thus, a specific user i only needs to know the polynomial p(i, y) so that each user only knows a part of the total polynomial, the polynomial being defined by Equation 11 (Eq. 11):

p(x,y)=(x⁰,x¹, . . . ,xⁿ⁻¹)A(y⁰,y¹, . . . ,yⁿ⁻¹)^{T} Eq. 11

wherein A is a symmetrical n×n element matrix.

Each user only has to store n coefficients in the form of the vector bᵢ as described by Equation 12 (Eq. 12):

bᵢ=(i⁰,i¹, . . . ,iⁿ⁻¹)A Eq. 12

Calculation of the key kᵢⱼ then involves firstly calculating (j⁰, j¹, . . . ,jⁿ⁻¹) and then performing scalar multiplication of this vector and the vector bᵢ.

The present invention employs certificate functionality based on polynomials, for example as utilized in Blom's scheme. In general terms, as depicted in FIG. 2, the CA chooses a random secret P(y, x) and then uses the secret to sign a public string m_{A} to generate a signature for a device A. The CA secretly sends this signature to the device A, for example by way of encryption. Any device B also having obtained some secret information from the CA can explicitly or implicitly verify the authenticity of m_{A} such that the device B uses the public string m_{A} to generate a key k_{AB}; only the device A, by using some public information on the device B, is also capable of generating this key k_{AB} provided that the string m_{A} is authentic. Thus, the device B is able to use the key k_{AB} to protect data that it sends to the device A.

In FIG. 2, an initial set-up phase is implemented wherein the CA chooses a random, secret and a symmetrical bi-variate polynomial P(x,y) such that P(x,y)=P(y, x) for all x and y. The CA evaluates the polynomial P(y, x) as in y=m_{A} to obtain a polynomial P(m_{A}, x) wherein P(m_{A}, x) is a signature on m_{A}. The CA then sends this uni-variate polynomial P(m_{A}, x) to the device A. Moreover, in the set-up phase, the CA secretly sends a polynomial P(b, x) to the device B wherein b is some public string referring to the device B. Both the strings m_{A} and b are public strings which can be stored in a public database or can be given to the devices A, B respectively.

After the aforementioned set-up phase, if the device B explicitly wants to verify the authenticity of a version of the string m_{A} in its possession, for example as depicted in FIG. 3, the device B implements a verification step. In the verification step, the device B chooses a random number r. Thereafter, the device B evaluates the polynomial P(b, x) by equating x=m_{A} to obtain a key k_{AB}=P(b, m_{A}). Next, the device B encrypts the random number r using the key k_{AB}, namely the device B determines E(k_{AB}, r) and sends this encryption to the device A.

On reception of the encryption E(k_{AB}, r), the device A evaluates the polynomial P(m_{A}, x) wherein x=b in order to obtain a derived key k′_{AB}=P(m_{A}, b). Next, the device A then sends a number r′=D(k_{AB}′, E(k_{AB}, r)) to the device B wherein D denotes decryption. The device B then only accepts the authenticity of m_{A} provided that the numbers r=r′ as verification. In such verification after the set-up phase, the CA is not involved, although the device A is required to be available on-line. FIG. 3 corresponds to explicit authentication according to the invention.

As depicted in FIG. 4, the device B is only able to send privileged information X to the device A subject to the content of the string m_{A}. The information X is, for example, audio or video content; moreover, the string m_{A} preferably includes indications concerning whether or not the device A is authorized to play the content. Thus, in a practical use of the present invention, the device A sends a request “Req (X)” for the information X to be sent to it. In response to receiving the request “Req (X)”, the device B firstly retrieves the string m_{A}. It then uses the string m_{A} to verify whether or not the device A is allowed access to the information X, namely “Ver m_{A} wrt X”. If the device B finds that the device A is indeed permitted to access the information X, the device B computes the key “k_{AB}=P(b, m_{A})” and then proceeds to encrypt the information using the key k_{AB}, namely “E(k_{AB}, X), and sends the encryption to the device A.

Upon receipt of the encryption, the device A computes a key “k_{AB}′=P(m_{A}, b) and then computes the content as “X′=D(k_{AB}′, E(k_{AB}, X)”. In a situation where the string m_{A}used by the device B is authentic, the device A will compute a proper value for the key, namely the keys k_{AB} and k_{AB}′ will correspond, so the device A is able to access the information X. Conversely, in an event of m_{A} being modified to the string m_{A}′, the device B will not be able to verify explicitly the authenticity of m_{A}′ but will generate a key k_{AB}′=P(b, m_{A}′) and use it to encrypt the information X; on account of properties of the Blom's scheme incorporated into the present invention, the device A will not be able to compute the key k_{AB}′ knowing only m_{A}′ and P(m_{A}, X) and the device B then implicitly verifies the authenticity of the string m_{A}. In both cases, the device A is able to verify authenticity provided that the device B is the originator of the messages, for example B adds a Message Authentication Code to the message sent to the device A.

Whereas FIG. 3 and associated description correspond to explicit authentication, FIG. 4 corresponds to implicit authentication.

The invention as described in the foregoing superficially resembles public key certificates in the respect that on-line access to the CA 20 is not required to certify authenticity of the string m_{A}. On account of Blom's scheme being preferably utilized in the present invention, a modified string m_{A} arising in interaction between the two devices A, B will result in a failed authenticity check in a similar manner to normal public key certificates. However, there are significant differences between the present invention and public key certificate systems.

In schemes illustrated in FIGS. 1 to 4, the device B requires assistance from the device A to verify authenticity of the string m_{A}, therefore the device A is required to be accessible on-line; such on-line access is in contrast to public key certificates which accommodate verification by knowledge of a public key of the CA, namely public verification.

Moreover, the schemes of FIGS. 1 to 4 rely on the devices A, B keeping the certificates P(m_{A}, x), P(b, x) respectively secret; however, the device A does not always benefit from keeping the certificate P(m_{A}, x) secret in contrast to contemporary cryptographic systems employing secret and private keys. In the invention, the device A can be regarded as being a compliant device which does not expose its private information; moreover, P(m_{A}, X) is not only able to serve as a certificate but also behave as the device A's private key in which case it is disadvantageous for the device A to publish the certificate P(m_{A}, x).

In schemes of FIGS. 1 to 4, the security of public key certificates depends on some computationally hard problem, for example a discrete logarithm problem or the factoring of large prime numbers. Security provided by the present invention described in the foregoing depends on properties of Blom's scheme which provides n-secure properties. Thus, if n is the degree of the polynomials for the secret P(y, x), a potential attacker is required to use more than n polynomials to form P(m_{A}, x) and to be able to generate the certificate P(m_{A}′, s). In schemes of the invention, the devices A, B only use polynomial evaluations in finite fields and symmetrical key encryption which is less computationally expensive than public key operations.

The invention illustrated in FIGS. 1 to 4 can be implemented based on other schemes than Blom's scheme. For example, the present invention as described in the foregoing can be arranged to employ Identity Based Encryption (IBE) as an alternative to Blom's scheme. IBE is defined as being a public key encryption algorithm wherein a public key can be any string and a corresponding private key is computed such that it matches the public key. IBE is clearly distinguished from other public key algorithms wherein only a private key can be chosen arbitrarily or wherein neither the public key nor its complementary private key can be chosen arbitrarily.

An advantage of using Blom's scheme in the present invention is that a value used to evaluate for the certificate P(y, x) can be chosen arbitrarily and hence allows any information to be stored in this value. Moreover, this value is public and therefore serves substantially as a public key. Moreover, Blom's scheme when employed in the present invention is computationally simpler than using the IBE.

It will be appreciated that embodiments of the invention described in the foregoing are susceptible to being modified without departing from the scope of the invention as defined by the accompanying claims.

In the present invention depicted in FIGS. 1 to 4, the devices A, B derive a key P(m_{A}, b)=P(b, m_{A}); conveniently, this key is referred to as a “master key”. It is often desirable to derive a random key based on this master key so that a new random key is generated for each session. At least several hundred standard protocols can potentially be used to derive a random key based on a common master key as described in a publication “Handbook of Applied Cryptography” by A. Menezes, P. van Oorschot and S. van Stone, published by CRC Press 1996 which is hereby incorporated by reference.

Thus, in the context of the present invention, the string m_{A} is used to store information which should be verifiable. In many practical situations, it is not practical to store information, for example program content, directly in the string m_{A} as it would render the string inconveniently long. In order to address such a problem of unwieldy string size, it is preferably that the string includes a down-sized edited version, also known as a “digest”, of the information as described by Equation 13 (Eq. 13):

m=h(m_{D1}) Eq. 13

using the aforementioned one-way hash function.

A further embodiment of the invention will be described, the embodiment utilizing certification functionality as described in the foregoing.

In FIG. 5, there is shown a simple content management system indicated generally by 200. The system 200 includes a Content Rights Authority (CRA) 210 which is operable to issue content rights to devices included within the system 200; these content rights allow the devices to play, for example, a certain piece of content. A right to play a given content Cᵢ is conveniently denoted by R_{Ci}. In practice, the CRA 210 is conveniently implemented as an “e-shop”, for example an Internet web-site. The system 200 further comprises first and second Content Managers (CM₁, CM₂) 220, 230 respectively preferably implemented as trusted servers which contain or have access to content, preferably unencrypted content. The CM₁, CM₂ 220, 230 are, for example, implemented as set-top boxes or other trusted devices interfacing to the Internet. Moreover, the system 200 also includes devices D1, D2, D3 denoted by 300, 310, 320 respectively, these devices being operable to render content, for example replay content. The devices 300, 310, 320 are preferably, in practice, implemented as video or audio rendering devices such as a video display or audio equipment.

Operation of the system 200 will now be described with reference to FIG. 5.

In the system 200, the device D1 300 obtains, for example by payment, right to play program content denoted by C₁, C₂ and C₃ up to a certain time limit T₁. Similarly, the device D2 obtains, for example also by payment, rights to play the content C₁ and C₂ up to certain time T₂. Moreover, the device D3 obtains rights to play the content C₂ up to a time T₃. Acquiring these rights for the devices D1, D2, D3 enables the devices to receive publicly corresponding data content strings m_{D1}, m_{D2}, m_{D3} respectively as conveniently described by Equations 14, 15 and 16 (Eqs. 14, 15 and 16) and also included in FIG. 5:

m_{D1}=D1∥R_{C1}∥R_{C2}∥R_{C3}∥T₁ Eq. 14

m_{D2}=D2∥R_{C1}∥R_{C2}∥T₂ Eq. 15

m_{D3}=D3∥R_{C2}∥T₃ Eq. 16

where ∥ denotes concatenation. In association with publicly receiving the strings m_{D1}, m_{D2}, m_{D3}, the devices D1, D2, D3 also secretly receive corresponding polynomials P(h(m_{D1}), x), P(h(m_{D2}), x), P(h(m_{D3}), x) respectively, wherein P(y, x) is a random symmetrical polynomial of sufficiently high degree as described in the foregoing, the polynomials for the devices D1, D2, D3 being chosen by the Content Rights Authority (CRA 210).

The CRA 210 accepts the CM₁, CM₂ are trusted servers and they secretly receive polynomials P(h(CM₁),x), P(h(CM₂),x) respectively, both of these servers storing the contents C₁, C₂, C₃.

In operation, the device D1 sends a request to CM₁ for the content C₃. This request includes a reference to the requested content, namely ID_{C3}, and also the string m_{D1} as provided in Equation 14. Upon reception of this request, CM₁ 220 verifies if rights R_{C3} for the requested content C₃ is comprised in the content string m_{D1} and also verifies whether of not the time at which the request is sent is earlier than the time T₁. If all checks made in association with the request from the device D1 300 are found to be valid, the CM₁ 220 performs the following steps:

(a) the CM₁ 220 computes a down-sized edited version of the string m_{D1}, namely a string m=h(m_{D1});
(b) the CM₁ 220 evaluates a polynomial P(h(CM₁),x) wherein x=m from (a) above to obtain a polynomial decryption key K;
(c) the CM₁ 220 computes an encrypted version of the content C₃ using the K from (b) above, namely E(K, C₃);
(d) the CM₁ 220 sends the encrypted version E(K, C₃) of the content C₃ to the device D1 300.

Upon receipt at the device D1 300 of encrypted data E(K, C₃) sent from CM₁ 220, the device D1 300 evaluates a polynomial P(h(m_{D1}), x) wherein x=h(CM₁) to obtain a decryption key K′. Next, the device D1 processes the encrypted data E(K, C₃) to derive a decrypted version C₃′ of the data content C₃ according to Equation 17 (Eq. 17):

C₃=D(K′,E(K,C₃)) Eq. 17

Assuming that the device D₂ 310 requests the content C₃ from CM₂ 230, the device D₂ does not have rights to the data content C₃. When CM₂ receives the request for the content C₃ and the string m_{D2}=D₂∥R_{C1}∥R_{C2}∥T₂, CM₂ will notice that RC₃ is not part of m_{D2} and therefore it will not send the data content C₃ to the device D₂ 310. Clearly, the device D₂ 310 could send a modified string m′_{D2}=D₂∥R_{C1}∥R_{C3}∥T₂ to CM₂. CM₂ will accept this modified string, evaluate P(h(CM₂),x) in x=h(m′_{D2}) to obtain the key K′ and send E(K′, C₃) to the device D₂. However, the device D₂ will not be able to compute the key K′ when it has access only to the polynomial P(h(m_{D2}), x). Therefore, it is not possible for the device D₂ 310 to decrypt the received content. Moreover, it is substantially impossible for the device D₂ 310 to modify its content rights and gain access to the content C₃.

Clearly, in the system 200, every device D can request content from every CM and the CM will be able to explicitly or implicitly verify content rights. In the system 200, similarly in other related systems using public key security techniques, the CRA 210 only plays a role in issuing content rights not required on-line during content delivery. The devices D cannot modify content rights or the expiry time because they then cannot generate keys used by the CM's to encrypt or decrypt content.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1. A method of providing digital certification functionality in a network (10) comprising a certification authority (20) and at least first and second devices (30, 40) connectable in communication with the authority (20), the method including steps of:
(a) at the authority (20), generating a secret P, applying the secret P to sign a data string (m_{A}) on behalf of the first device (30, A), and then communicating (50) the signed string to the first device (30, A);
(b) communicating (60) secret information from the authority (20) to the second device (B, 40), said secret information for verifying authenticity of the string (m_{A}), said second device (40, B) being operable to use the secret information to generate a second key (k_{AB2}) for verifying authenticity of the string (m_{A});
(c) generating a first key (k_{AB1}) at the first device (30, A) using public information pertaining to the second device (40, B), said first key (k_{AB1}) being susceptible to generation provided that the string (m_{A}) is authentic;
(d) applying the second key (k_{AB2}) to protect data for communication from the second device (40, B) to the first device (30, A); and
(e) at the first device (30, A), applying the first key (k_{AB1}) to access the protected data communicated from the second device (40, B) to the first device (30, A).

2. A method according to claim 1, wherein accessing the protected data in step (e) is implemented without requiring on-line access to the authority (20) during verification.

3. A method according to claim 1, wherein the secret P is a bi-variate polynomial.

4. A method according to claim 1, wherein the first key (k_{AB1}) is a polynomial evaluated using a public string relating to the second device (40, B).

5. A method according to claim 1, wherein, in step (a), the signed string is communicated secretly from the authority (20) to the first device (30, A).

6. A method according to claim 5, wherein the signed string is communicated secretly using encryption techniques,

7. A method according to claim 1, wherein verification of the communicated protected data at the first device (30, A) is explicit.

8. A method according to claim 1, wherein verification of the communicated protected data at the first device (30, A) is implicit.

9. A method according to claim 1 based on at least one of: Blom's scheme, Identity Based Encryption (IBE).

10. A communication system (10) including a certification authority (CA, 20) and a plurality of devices (30, 40) arranged in mutual communication, the system (10) being operable according to the method of claim 1.

11. A digital certificate for data verification in a communication network (10) operable according to a method of claim 1.

12. Encrypted data susceptible to verification by applying a method according to claim 1.

13. Encrypted data according to claim 12, said data including audio and/or video program content.
